(19) United States
(12) Patent Application Publication
(10) Pub. No.: US 2014/0006970 A1
(43) Pub. Date: Jan. 2, 2014

(54) Automatic Contact Creation Based on User Interaction

(71) Applicants: Brandon Casey, San Jose, CA (US); Joel Levin, Cupertino, CA (US); Eddie Fan, Milpitas, CA (US); Melissa Chan, Hayward, CA (US)

(72) Inventors: Brandon Casey, San Jose, CA (US); Joel Levin, Cupertino, CA (US); Eddie Fan, Milpitas, CA (US); Melissa Chan, Hayward, CA (US)

(21) Appl. No.: 13/534,918

(22) Filed: Jun. 27, 2012

(51) Int. Cl. G06F 3/01

(52) U.S. Cl. 715/753

(57) ABSTRACT

Contact information may be automatically generated on a device based on an interaction by the user of the device with another individual. A record of the interaction may be obtained by the device and, if it is determined that the interaction satisfies an interaction rule, information from the record of the interaction may be utilized to obtain contact information for the individual. The contact information may be obtained by extracting the contact information directly from the record of the interaction or by extracting an identifier of the individual from the record of the interaction and querying a remote device for the contact information. The obtained contact information may then be stored on the user's device.

### BACKGROUND

This disclosure relates generally to the creation of contact information for another person on a user's device. More particularly, but not by way of limitation, it relates to techniques for identifying a user's interaction with another person and retrieving contact information for that person.

A contacts directory on an electronic device may be utilized to store information for individuals with whom a user of the device frequently interacts. Typically, a contact record associates contact information for a variety of different communication media (as well as other information) with a particular individual. For example, a contact record for a particular individual may provide one or more telephone numbers, one or more email addresses, one or more physical addresses, and other information for the individual. This information may allow a user of the device on which the information is stored to quickly direct an outgoing communication to the individual and may present identification information for the individual upon receipt of an incoming communication from the individual.

Although contact information enables more efficient communications for a user of an electronic device, storing the information on a device requires some manual action on the part of the user of the device. As such, contact information for a particular individual on a user's device may lag behind a real-life relationship between the user and the individual. For example, if a user begins interacting with a new acquaintance, contact information for the new acquaintance will not be available on the user's device until the user takes some action to either enter the information or retrieve the information electronically. Therefore, the user may wish to call, email, or otherwise interact with the new acquaintance but may not have their information available.

### SUMMARY

In one embodiment, the invention provides a method to automatically create a contact for another person on a device of a user. The method includes identifying an interaction between the user of the device and the other person, determining whether the interaction satisfies an interaction rule, and, if so, obtaining additional information about the other person based on the interaction. The additional information may then be utilized to create a contact for the other person on the device. The method may be embodied in program code and stored on a non-transitory storage medium. The stored program code may be executed by a processor that is part of, or controls, a device on which the contact is created.

In another embodiment, a method includes obtaining a record of an interaction between a user of a device and another person and extracting an identifier of the other person from the record. One or more interaction rules, including whether the interaction is associated with existing contact information that is stored on the device, may then be applied to the interaction. If it is determined that the interaction satisfies at least one interaction rule, the identifier may be utilized to obtain additional information about the other person and a contact may be created on the device for the other person using the obtained information. The contact information may be stored in a contacts data store on the device. The method may be embodied in program code and stored on a non-transitory storage medium. The stored program code may be executed by a processor that is part of, or controls, a device on which the contact information is stored.

### BRIEF DESCRIPTION OF THE DRAWINGS

FIG. 1 is a block diagram illustrating an interaction between two users of electronic devices in accordance with one embodiment.

FIG. 2 is a flowchart that illustrates the automatic creation of contact information on a user's device based on the user's interaction with another individual in accordance with one embodiment.

FIG. 3 is a block diagram illustrating the retrieval of contact information from a remote device based on information extracted from a record of an interaction between a user of a device and another individual in accordance with one embodiment.

FIG. 4 illustrates contact information extracted from a record of an interaction between a user of a device and another individual in accordance with one embodiment.

FIG. 5 is a block diagram illustrating the transmission of contact information to a remote device by a first user and the subsequent retrieval of the contact information from the remote device by a second user after an interaction between the first user and the second user in accordance with one embodiment.

FIG. 6 is a block diagram illustrating the grouping of contact information in a contacts data store on an electronic device.

FIG. 7 is a block diagram for an illustrative electronic device in accordance with one embodiment.

### DETAILED DESCRIPTION

This disclosure pertains to the automatic creation of contact information on a device based on an interaction of a user of the device. In general, techniques are disclosed for identifying an interaction, determining whether the interaction satisfies a rule for the automatic creation of contact information, and using information extracted from a record of the interaction to obtain and store contact information.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art having the benefit of this disclosure.

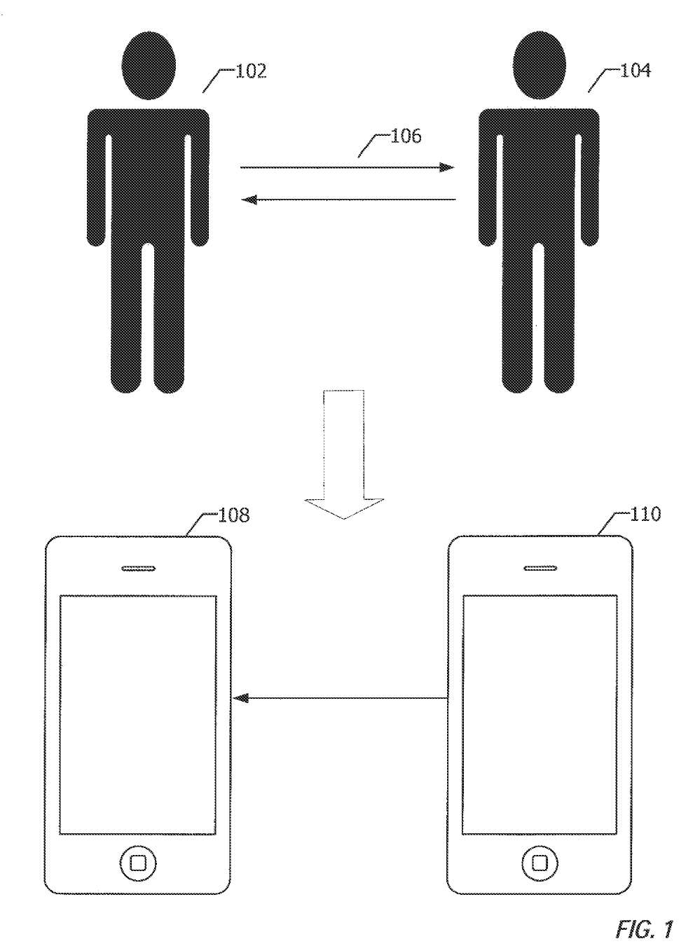

Referring to FIG. 1, user 102 interacts with user 104 as illustrated by arrows 106. In one embodiment, the users may send and receive emails, telephone calls, social network messages, text messages, chat messages, etc. utilizing devices 108 and 110. In another embodiment, interaction 106 may not occur directly via devices 108 and 110. For example, as will be described in greater detail below, the users may simply attend the same scheduled meeting or may interact using other devices (e.g., work computers and social-media networks).

In one embodiment, users 102 and 104 may be relatively new acquaintances. For example, users 102 and 104 may have recently been assigned to the same project at work. Although users 102 and 104 have interacted with each other, their devices 108 and 110 may not reflect this relationship. That is, users 102 and 104 may not have taken the time to manually create a contact for the other user on their respective devices. Consequently, when the users subsequently interact (or attempt to interact), devices 108 and 110 may not be able to provide the information desired by one or both of the users. By way of example, user 102 may receive a phone call at device 108 from user 104 using device 110, but may only receive a caller identification number (without user 104's name) because user 104's number does not correspond to a stored number in the contact information on device 108. Similarly, user 102 may want to send a text message, instant message application message, or email to user 104 from device 108 but may not have a telephone number for device 110, an instant message user ID for user 104, or an email address for user 104.

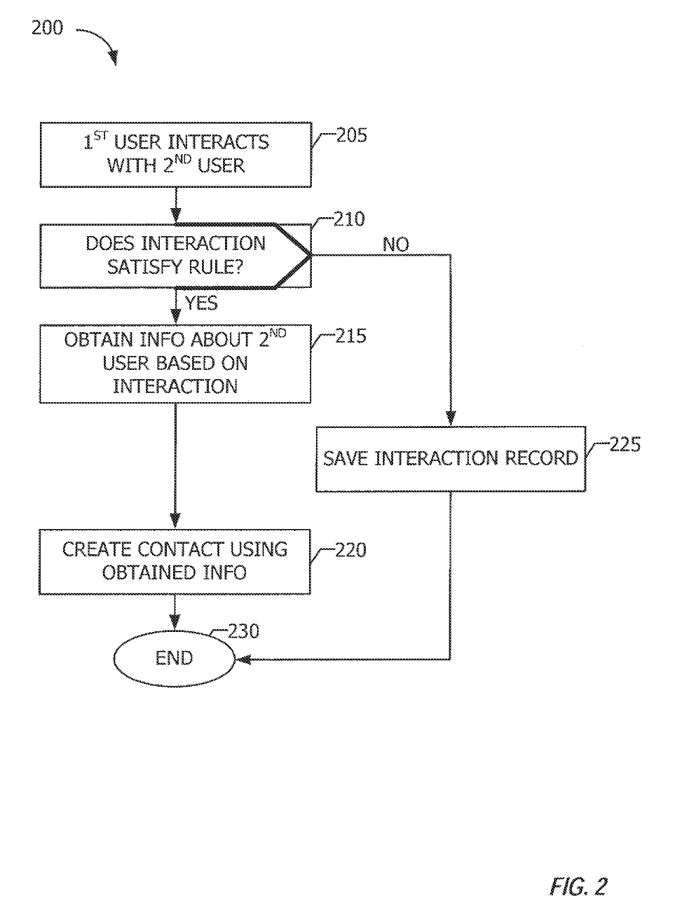

Referring to FIG. 2, automatic contact creation process 200 in accordance with one embodiment may recognize the interaction between a first user and a second user (block 205). As described briefly above, the interaction may involve a telephone call, an email message, a social network message, a text message, an instant message application message, a meeting invitation, or any other interaction for which a record may be available. In one embodiment, a record of the interaction may be received by a contacts application (i.e., an application that stores contact information for acquaintances of the first user) executing on the device of the first user. In a first embodiment, the contacts application may periodically request records of interactions from other software applications that execute on the device. For example, a contacts application executing on a device may request recently received or sent emails from an email application executing on the device. In one embodiment, a complete record of the interaction (e.g., the entire email) may be received. In another embodiment, a partial record of the interaction (e.g., email header information) may be received.

The contacts application may also request interaction information from a remote device. For example, the contacts application may utilize the user's credentials for an email account to directly retrieve records of recent emails from a server-side email application. Likewise, the contacts application may utilize the user's access credentials for a synchronization account to retrieve records associated with interactions that took place on another of the user's devices. For example, where a user has linked theft mobile phone, personal laptop, and work computer, the contacts application on the mobile phone (or one of the other devices) may access the user's synchronization account (e.g., a server-side synchronization application) to retrieve interaction records (e.g., emails, meeting requests, etc.) for interactions conducted using the laptop or work computer.

After an interaction has been recognized, it may be determined if the interaction satisfies one or more interaction rules (block 210). In one embodiment, a rule may define ways to determine whether the interaction warrants the creation of contact information. In one embodiment, a rule may first determine whether an interaction is associated with any existing contact information that is stored on the device. As used herein, an interaction is associated with existing contact information if information extracted from a record of the interaction matches any contact information stored on the device. For example, in one embodiment, an identifier of the second user (e.g., the user's name, email address, telephone number, etc.) may be extracted from the record of the interaction. The existing contact information on the device may then be searched for the identifier to determine if the interaction is associated with the existing contact information. If it is determined that the interaction is associated with contact information that is already stored on the device, the interaction may not need to be further evaluated.

A rule may further set forth an interaction threshold. For example, a rule may define a threshold number of interactions that must be exchanged between the first user and the second user before a contact application obtains contact information for the second user. In such an embodiment, a single email or telephone call from the first user to the second user may not imply a relationship between the users that is worthy of establishing contact information. Conversely, an exchange of ten emails or telephone calls between the first user and the second user over a certain time period may indicate that contact information for the second user would be beneficial to the first user. An interaction threshold may also be dynamic. For example, if multiple identifiers (e.g., multiple email addresses in the “to,” “cc,” or “bcc” lines) are included in a record of an interaction and one of the identifiers corresponds to contact information that is already stored on the device, the interaction threshold may be reduced for the other identifier. For instance, the interaction threshold for the unrecognized identifier may be decreased from 10 emails to 5 emails because the identifier is known to be associated with an identifier that is associated with existing contact information.

In another embodiment, a score may be applied to an interaction or series of interactions. In such an embodiment, each type of interaction may be assigned a weight and a score may be generated for a particular interaction. For example, a reply to an email may carry greater weight than an original email (the former indicating a back and forth interaction) and an email message to a direct recipient (i.e., a recipient listed in a “to:” line) may be accorded greater weight than an email to an indirect recipient (i.e., a recipient listed in a “cc:” line or “bcc:” line). In such an embodiment, each interaction in a series of interactions may be assigned a score and it may be determined that an interaction or series of interactions satisfies a rule if an interaction score exceeds a threshold defined by the rule.

It should be noted that an interaction does not necessarily refer to a single occurrence. That is, an interaction rule may require a series of separate interactions over a particular time period in order to be satisfied. Therefore, it will be recognized that determining whether a particular interaction satisfies a rule may include analyzing the particular interaction (e.g., email, phone call, etc.) in light of previous interactions with the same user. For example, a particular interaction rule may be satisfied where a composite interaction score (e.g., the sum of interaction scores for each interaction in a series of interactions) for all of the interactions between two users over a certain time period exceeds a threshold.

If it is determined that a particular interaction (or series of interactions) does not satisfy a rule (the “No” prong of block 210), a record of the interaction may be saved for use in determining whether a subsequent interaction between the users satisfies the rule (block 225). In one embodiment, a partial record of the interaction (rather than the complete record of the interaction) may be saved. For example, an identifier describing the type of interaction (e.g., direct email, reply email, initiated telephone call, received telephone call, etc.), the second user, a score associated with the interaction, and any other relevant information may be stored in a data store. Therefore, a subsequent interaction between the first and second user may be evaluated in light of previous interactions by quickly retrieving previous interaction records from the data store.

If it is determined that the interaction satisfies one or more interaction rules (the “Yes” prong of block 210), information about the second user may be obtained based on the interaction or series of interactions that satisfied the rule. As will be described in greater detail below, information may be obtained based on an interaction in a number of different ways. In one embodiment, an identifier of the second user (e.g., the user's name, email address, telephone number, etc.) may be extracted from a record of the interaction and utilized to search an information database to retrieve additional contact information for the second user. In another embodiment, the contact information for the second user may be extracted from the record of the interaction itself. In yet another embodiment, the second user may publish theft contact information and allow it to be shared with any user with whom they have had an interaction.

The obtained contact information may then be used to create a contact for the second user on the first user's device (block 220). As used herein, a contact refers to a record in a data store that contains contact information for a person. In one embodiment, the contact may include contact information for multiple devices (e.g., work, mobile, and home phones) and/or multiple accounts (e.g., personal and work email accounts, social network account, etc.) associated with the person.

In one embodiment, a contact may contain predefined fields for the input of certain types of information. In such an embodiment, the obtained information may be saved in a corresponding field for the contact. For example, an obtained mobile telephone number may be saved in a predefined mobile telephone number field of the contact for the second user. In another embodiment, the contact may include additional fields for information that does not correspond to any of the predefined fields. Obtained information that does not correspond to one of the predefined fields may be saved in one of the additional fields. Once a contact has been created or it has been determined that an interaction does not satisfy a rule and a record of the interaction has been saved, automatic contact creation process 200 is complete.

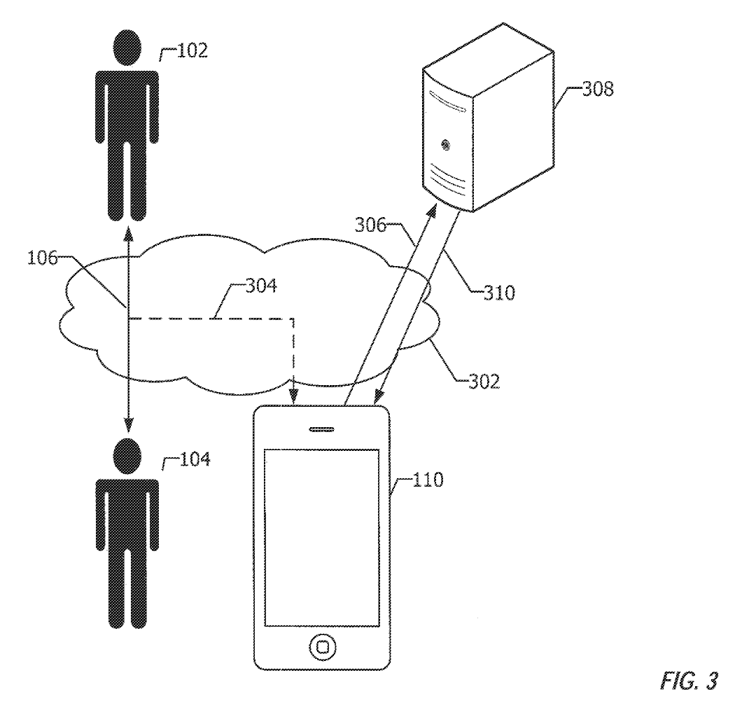

Referring to FIG. 3, a method in accordance with one embodiment for obtaining contact information for user 102 begins when interaction 106 is initiated between users 102 and 104. In the illustrated embodiment, interaction 106 may occur over communications network 302. Network 302 may take any form including, but not limited to, a local area network (LAN), a wide area network (WAN) such as the Internet or a combination of local and wide-area networks. Moreover, the network may use any desired technology (wired, wireless or a combination thereof) and protocol (e.g., transmission control protocol, TCP).

In one embodiment, interaction 106 may involve the indirect communication of information between users 102 and 104. By indirect, it is meant that information is communicated by a device under the control of one of the users to a remote device (e.g., a message server) for retrieval by, or transmission to, a device under the control of the other user. Examples of such indirect messages include email messages and social network messages. In another embodiment, interaction 106 may involve the direct communication of information between user 102 and 104. By direct communication, it is meant that the interaction involves a communication directly between devices under the control of users 102 and 104. Examples of direct communications may include telephone calls, SMS messages, and certain instant messaging messages.

In yet another embodiment, the interaction may not even involve explicit communication between users 102 and 104. For example, an interaction record may simply indicate that user 102 appears on a list of meeting attendees for a meeting that user 104 has attended. As is known, it is common practice for a meeting request to be issued through an email or calendar application. Typically, a meeting organizer will send a meeting request to multiple meeting participants. Each participant may thereafter reply to the organizer indicating whether they will or will not attend. An interaction may simply involve a first user and a second user (neither being the meeting organizer) each responding affirmatively to a meeting request. Consequently, an interaction may occur between two users that have not engaged in any explicit exchange of information (e.g., no direct email or telephone call between the users).

At some point, record 304 of interaction 106 may be received at device 110 (belonging to user 104). In one embodiment, record 304 may be a complete record of the interaction. For example, record 304 may include the entirety of an email exchanged between users 102 and 104. In another embodiment, record 304 may be a partial record that simply describes the interaction. For example, record 304 may provide a telephone number of a device used by user 102 to place a call to user 104, a duration of the call, etc.

If it is determined that interaction 106 (or a series of interactions between users 102 and 104) satisfies an interaction rule, device 110 may query a remote application executing on a remote device using an identifier for user 102 extracted from record 304. In the illustrated embodiment, device 110 may send request 306 via network 302 to remote server computer system 308 to retrieve contact information for user 102. Request 306 may include any identifier for user 102 that may allow the contact information for user 102 to be retrieved. Request 306 may additionally include credentials for user 104 that allow access to the remote application executing on remote server computer system 308. In one embodiment, if interaction 106 includes an email interaction, request 306 may include user 102's email address and/or a name associated with the email address extracted from record 304. Likewise, if interaction 106 includes a telephone call, request 306 may include a telephone number for user 102 extracted from record 304.

In one embodiment, server computer system 308 may host a directory such as a lightweight directory access protocol (LDAP) directory, an active directory (AD), a network information service (NIS) directory, or any other directory service. As is known in the art, such directory services are typically used by organizations to store contact and other information pertaining to employees, contractors, customers, suppliers, etc. In such an embodiment, the directory service may be accessible to certain users (e.g., employees) that can provide proper authentication information. In one embodiment, device 110 may determine that the request should be submitted to a directory server computer system if an interaction meets certain criteria. For example, if record 304 includes an en ail address for user 102, it may be determined if the domain name of the email address is associated with an employer or organization that maintains a directory server 308 to which user 104 has access. For instance, if record 304 includes an email from user 102 to user 104 from an email address user@samecompany.com, it may be determined that additional information may be obtained from a directory server such as server computer system 308. Likewise, if record 304 includes an telephone call from user 102 to user 104 from a telephone number that is associated with an employer or organization that maintains a directory server 308 to which user 104 has access, it may be determined that additional information may be obtained from directory server 308.

It will be understood by those of ordinary skill in the art that, in such an embodiment, request 306 may comply with a particular directory protocol and may, in fact, represent a series of requests. By way of example, if request 306 is presented to a LDAP server, it may include a Bind operation to authenticate user 104 followed by one or more search operations to identify information of interest. Based on the identifier extracted from record 304 (e.g., a user name, telephone number, email address, instant messaging identifier, social network identity, etc.), it may be possible to search the directory, identify the user, and retrieve additional contact information associated with the user. For example, a filter operation may identify user 102 in the directory based on an email address from record 304 and may result in response 310 that includes contact information such as a name, office phone number, mobile phone number, department, title, supervisor, etc. The information contained in response 310 may be utilized to create a contact for user 102 on device 110 (e.g., in a contacts application on device 110).

Although a directory server may contain beneficial information that is accessible in an enterprise context (e.g., where users 102 and 104 are both associated with an organization that maintains a directory that is accessible to one or both users), it may be the case that user 104 does not have access to such a directory or that user 102 is not listed in the directory. If it is determined that a user associated with information obtained in record 304 is not listed in a directory (or that user 102 is not likely to be listed in the directory), request 306 may be submitted to a web server that maintains contact information.

In such an embodiment, server computer system 308 may be one or more social network servers that host a social network application. In a similar manner to the retrieval of information from a directory server, request 306 may include authentication information for user 104 (e.g., user 104's social network account authentication information) and the identifier extracted from record 304 to obtain additional contact information for user 102. As is known, social network users may provide profile information that is associated with their social network account. As is also known, social network users may establish social network relationships with other social network users that allow them to interact via the social network. Some or all of a user's profile information may be available to other social network users with whom the user has established a social network relationship. Therefore, request 306 may allow user 104 to access theft social network account and to search through profiles of other social network users with whom user 104 has a social network relationship. It may be the case, for example, that user 104 is in a social network relationship with user 102 but does not have contact information for user 102 stored on device 110. Just as with a directory server, a server-side social network application (or any other web application that maintains contact information) may provide contact information as response 310.

Although interaction 106 and request 306/response 310 are illustrated as occurring over the same network 302, these actions may occur over separate networks. For example, an email may be sent via a wide-area network from user 102 to user 104 and request 306/response 310 may be conducted via a local area network. Moreover, although request 306 has heretofore been described as occurring only after an interaction rule is satisfied, it may also be the case that information is obtained via request 306 for an interaction that does not satisfy an interaction rule. In such an embodiment, additional information may be retrieved and associated with a particular interaction record even where the interaction does not warrant the creation of a contact. The additional information may allow subsequent interactions with the same user to be recognized. For example, if a first interaction involves a single email from a user, it may not satisfy an interaction rule for the creation of a contact. However, information extracted from a record of the email interaction may be utilized to obtain additional contact information for the user from a remote device such as server 308. If a subsequent interaction involves a telephone call (which may also not individually satisfy an interaction rule) the additional contact information obtained based on the first email interaction (e.g., a telephone number for the user) may allow the interactions to be associated with the same user such that the combination of interactions may satisfy an interaction rule for the creation of a contact. Consequently, information obtained from a record of an interaction of a first user with a second user may be utilized to obtain additional contact information for one of the users from a remote source.

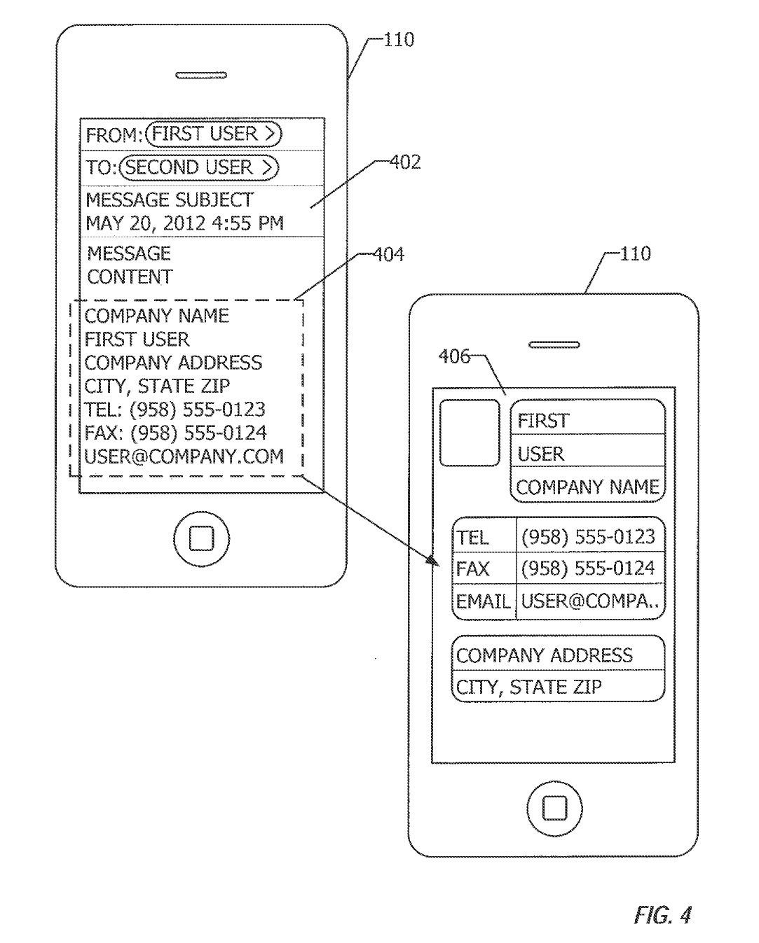

Referring to FIG. 4, a method to obtain contact information directly from a record of an interaction is illustrated. It was illustrated with respect to FIG. 3 that information extracted from a record of an interaction between users (e.g., a telephone number, email address, etc.) can be utilized to search for additional contact information. As illustrated in FIG. 4, contact information may also be retrieved directly from the record of the interaction in some cases. In the illustrated embodiment, second user (e.g., user 104) receives email message 402 from first user (e.g., user 102) on device 110. In one embodiment, email 402 may be viewed by user 104 on another device but the email may be retrieved by device 110 (e.g., as record 304 of the email interaction) to evaluate whether the email interaction warrants the creation of a contact on device 110 for user 102. As is common, the content of email message 402 may include signature 404 for user 102. Signature 404 may include additional contact information for user 102. In the illustrated embodiment, signature 404 includes a company name for user 102, a name for user 102, a company address for user 102, telephone and fax numbers for user 102, and an email address for user 102. Device 110 may parse through the content of email 402 to identify signature 404 and the information it contains. The information extracted from signature 404 may then be used to create contact 406 on device 110. In one embodiment, the information extracted from signature 404 may be used to populate predefined fields (e.g., first and last name, telephone number, email address, etc.) in a contacts application on device 110. Like the information obtained from a remote source, contact information may be extracted from the record of an interaction even when an interaction rule has not been satisfied. Although the illustrated embodiment has described the extraction of contact information from a signature in the body of an email message, it should be understood that contact information may be extracted from other portions of an email message or from the record of any interaction that includes such information (e.g., a name and telephone number may be extracted from a voicemail message). Accordingly, information may be extracted from the record of an interaction in lieu of, or in addition to, retrieving contact information from a remote device.

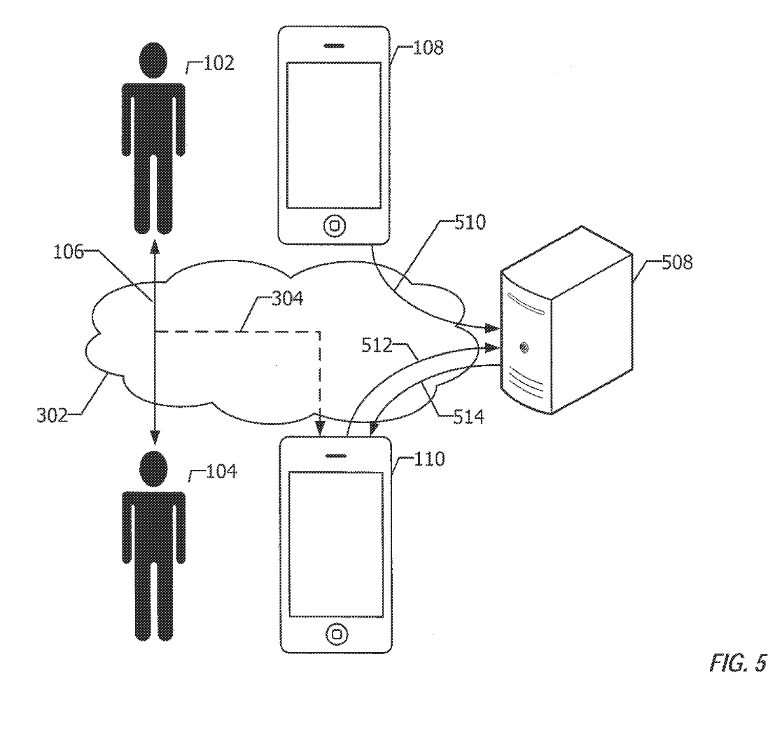

Referring to FIG. 5, in another embodiment, user 102 may select an option on device 108 to share contact information with anyone whom they have interacted with, initiated contact with, etc. Based on the setting, contact information for user 102 that is stored on device 108 may be provided via network 302 to a server-side contacts application executing on server computer system 508 (510). In one embodiment, the user's own contact information may be stored as a special contact in a contacts application on device 108. Separate contact information may be provided to the server-side contacts application for different types of contact information (e.g., separate work and personal contacts). In one embodiment, the server-side contacts application may be operated by (or controlled by) a manufacturer of device 108.

Thereafter, user 102 may interact with user 104 and record 304 of the interaction 106 may be received at device 110 in the same manner as described above. Based on information contained in record 304, device 110 may send request 512 to the server-side contacts application on device 508 to obtain contact information for user 102. In one embodiment, it may be required that request 512 include proof of interaction 106 in order to receive response 514 that includes contact information for user 104. If a contact is found for the information contained in request 512 (from record 304), the information contained in the contact may be provided in response 514. In such an embodiment, where user 102 has shared information from multiple contacts (e.g., work and personal) only the information from the contact for which the information in request 512 resulted in a match may be provided in response 514. For example, if interaction 106 involves a telephone call from a work phone of user 102, request 512 may include the work phone number of user 102 which may, in turn, result in the identification of a work contact for user 102 by the server-side contacts application. Accordingly, even if user 102 has provided a personal contact to the server-side contacts application, response 514 may include only the information from the work contact. As described above, the illustrated actions (interaction 106 and communications 510, 512, and 514) may not necessarily occur over the same network 302. Moreover, it should be recognized that contact information based on an interaction between users may be obtained in ways that have not been described or based on a combination of the methods described herein.

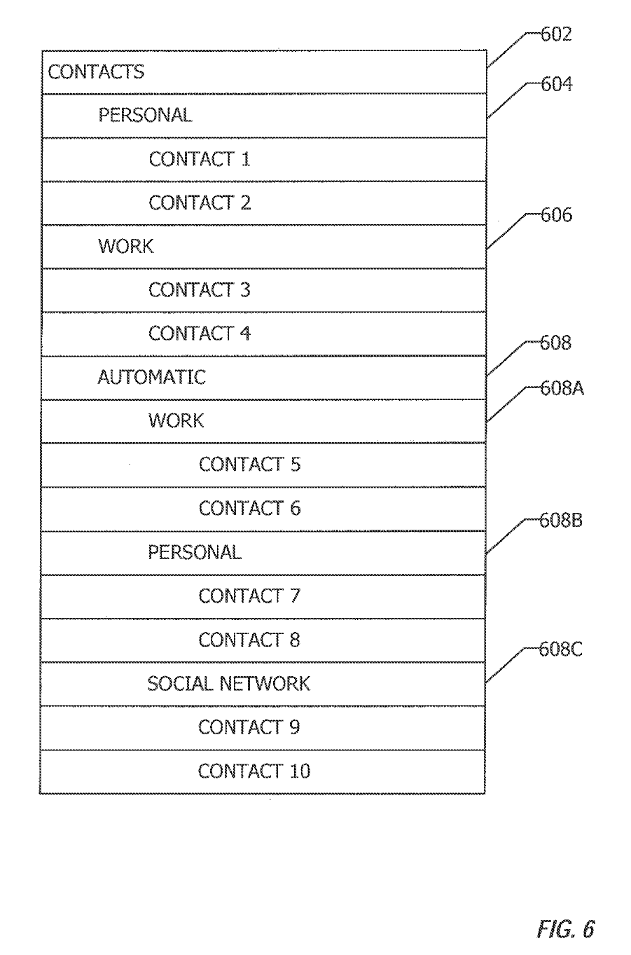

Referring to FIG. 6, the organization of contacts within contacts data store 602 may include a grouping level for contacts that are created automatically based on interactions of a user. In the illustrated embodiment, contacts data store 602 may include both user-created and predefined groups. For example, a first grouping level may include user-created personal group 604, user-created work group 606, and predefined automatic group 608. Each of these groups may additionally contain subgroups. For example, automatic group 608 may include work subgroup 608A, personal subgroup 608B, and social network subgroup 608C. In one embodiment, a user may place manually created contacts (e.g. Contacts 1, 2, 3, and 4) within an appropriate user-created group or subgroup. Of particular relevance to the instant disclosure, in one embodiment contacts that are automatically created based on an interaction of the user may be assigned to automatic group 608 within contacts data store 602. In such an embodiment, the segregation of automatic contacts from manually created contacts may allow a user to quickly determine that a contact appeared on a device automatically as a result of an interaction. Contacts that are automatically created on a device based on an interaction of the user may be further categorized according to an interaction rule that led to the contact's creation. For example, a contact resulting from an interaction involving a work email account or work telephone of a user may be automatically placed in work subgroup 608A, a contact resulting from an interaction involving a personal email account or personal telephone of a user may be automatically placed in personal subgroup 608B, and a contact resulting from a social network interaction may be automatically placed in social network subgroup 608C. It will be understood that the described groups and subgroups are provided by way of example and are not intended to be limiting in any manner.

In one embodiment, contacts that are automatically created based on a user interaction may be removed if there is no subsequent interaction over a certain time period. In one embodiment, an automatically created contact may be deleted if there is no direct use of the contact on the device over a three-month time period. In another embodiment, the contact may be maintained if there is some interaction related to the contact even if the device is not directly used for the interaction. For example, if the user of the device sends an email from a work computer to an email address associated with a contact that is saved on the device, the contact may still be maintained even if it is not directly used on the device. Therefore, in addition to determining whether an interaction may warrant the creation of a contact, a record of an interaction may also be evaluated to determine whether it is related to an existing automatically created contact in order to maintain records pertaining to the use of automatically created contacts. In one embodiment, contacts that are automatically created based on a user interaction may be subsequently moved to a user-created group. In such an embodiment, the user may enter additional information for the contact and the contact may be protected against removal based on non-use.

In another embodiment, a user may establish a blacklist of contacts that should not be created automatically. For example, although an employee may receive updates from a CEO of their company describing the company's performance, they may not want a contact to be created based on that interaction. Therefore, a contact blacklist may identify the CEO by name, email address, etc. In another embodiment, a user may manually delete an automatically generated contact from data store 602. In such an embodiment, a deleted automatically generated contact may be added to a blacklist such that the contact is not added based on a subsequent interaction.

Although it has generally been indicated that a contacts application on a device may retrieve interaction information, apply one or more interaction rules, and obtain contact information if an interaction rule is satisfied, it is not necessary that these functions be performed by the contacts application. In another embodiment, an application that is responsible for handling the interaction may perform these actions. For example, a client-side social network application may receive a social network message, determine whether the message satisfies an interaction rule, and obtain contact information related to the interaction (e.g., by querying an associated server-side social network application for the contact information). In such an embodiment, the application may then utilize an application programming interface to create a contact in the contacts application.

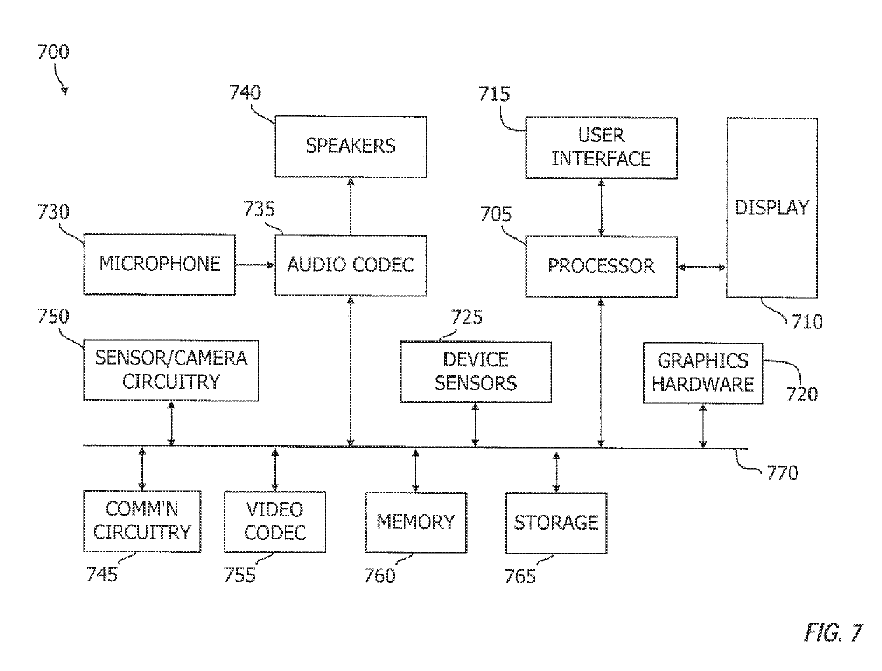

Referring to FIG. 7, a simplified functional block diagram of an illustrative electronic device 700 is shown according to one embodiment. Electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture unit 750, video codec(s) 755, memory 760, storage 765, and communications bus 770. Electronic device 700 may be, for example, a personal digital assistant (PDA), personal music player, mobile telephone, notebook, laptop or a tablet computer, desktop computer, or server computer. More particularly, any of the devices described above may take the form of device 700.

Processor 705 may execute instructions necessary to carry out or control the operation of many functions performed by device 700. Processor 705 may, for instance, drive display 710 and receive user input from user interface 715. User interface 715 can take a variety of forms, such as a button, keypad, dial, a click wheel, keyboard, display screen and/or a touch screen. Processor 705 may also, for example, be a system-on-chip such as those found in mobile devices and include a dedicated graphics processing unit (GPU). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable graphics processing unit (GPU).

Sensor and camera circuitry 750 may capture still and video images that may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or code organized into one or more modules and written in any desired computer programming language. When executed by, for example, processor 705 such computer program code may implement one or more of the methods described herein.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause the processor to:
identify an interaction between a user of a device and another person;
determine whether the interaction satisfies an interaction rule;
obtain information about the other person based on the interaction when it is determined that the interaction satisfies the interaction rule; and
create a contact for the other person on the device comprising at least some of the obtained information.

2. The non-transitory program storage device of claim 1, wherein the instructions to cause the processor to identify an interaction between a user of the device and another person comprise instructions to cause a contacts application on the device to retrieve a record of the interaction from a local application executing on the device.

3. The non-transitory program storage device of claim 2, wherein the local application comprises at least one of an email application, a social network application, and a calendar application.

4. The non-transitory program storage device of claim 1, wherein the instructions to cause the processor to identify an interaction between a user of the device and another person comprise instructions to cause a contacts application on the device to retrieve a record of the interaction from a remote device.

5. The non-transitory program storage device of claim 4, wherein the instructions to cause the contacts application to retrieve a record of the interaction from a remote device comprise instructions to cause the processor to present access credentials for the user to the remote device.

6. The non-transitory program storage device of claim 1, wherein the instructions to cause the processor to determine whether the interaction satisfies an interaction rule comprise instructions to cause the processor to retrieve one or more records of one or more previous interactions between the user and the other person.

7. The non-transitory program storage device of claim 6, wherein the instructions to cause the processor to determine whether the interaction satisfies an interaction rule comprise instructions to cause the processor to assign a score to each of the previous interactions between the user and the other person.

8. The non-transitory program storage device of claim 7, wherein the instructions to cause the processor to determine whether the interaction satisfies an interaction rule comprise instructions to cause the processor to:
generate a composite interaction score based on the scores assigned to each of the interactions between the user and the other person; and
determine whether the composite interaction score exceeds a threshold score identified by the interaction rule.

9. The non-transitory program storage device of claim 1, wherein the instructions to cause the processor to obtain information about the other person based on the interaction comprise instructions to cause the processor to extract an identifier of the other person from a record of the interaction.

10. The non-transitory program storage device of claim 9, wherein the instructions to cause the processor to obtain information about the other person based on the interaction comprise instructions to cause the processor to query a remote application executing on a remote device for contact information of the other person using the identifier.

11. The non-transitory program storage device of claim 10, wherein the remote application comprises a directory application.

12. The non-transitory program storage device of claim 11, wherein the remote device comprises a lightweight directory access protocol (LDAP) server.

13. The non-transitory program storage device of claim 10, wherein the remote application comprises a social network application.

14. The non-transitory program storage device of claim 10, wherein the instructions to cause the processor to query a remote application executing on a remote device comprise instructions to cause the processor to present access credentials for the user to the remote device.

15. The non-transitory program storage device of claim 1, wherein the instructions to cause the processor to obtain information about the other person based on the interaction comprise instructions to cause the processor to extract the information from a record of the interaction.

16. The non-transitory program storage device of claim 1, further comprising instructions to cause the processor to save a record of the interaction when it is determined that the interaction does not satisfy the interaction rule.

17. A method to create a contact on a device, comprising:
obtaining, by a processor of a device, a record of an interaction between a user of the device and another person;
extracting, by the processor, an identifier for the other person from the record;
determining, by the processor, whether the interaction satisfies an interaction rule;
obtaining, by the processor, information about the other person based on the identifier when it is determined that the interaction satisfies the interaction rule; and
creating, by the processor, a contact for the other person on the device comprising at least some of the obtained information.

18. The method of claim 17, further comprising saving, by the processor, information associated with the interaction when it is determined that the interaction does not satisfy the interaction rule.

19. The method of claim 17, wherein the act of obtaining information about the other person comprises querying, by the processor, a remote device using the identifier.

20. A non-transitory program storage device, readable by a processor and comprising instructions stored thereon to cause the processor to:
obtain, by a device, a record of an interaction between a user of the device and another person;
extract an identifier of the other person from the record of the interaction;
determine, based on the identifier, whether existing contact information for the other person is stored on the device;
apply one or more interaction rules to the interaction;
obtain contact information for the other person based on the identifier when it is determined that no existing contact information for the other person is stored on the device and that the interaction satisfies at least one interaction rule; and
utilize the obtained contact information for the other person to populate a contacts data store on the device.

21. The non-transitory program storage device of claim 20, further comprising instructions to cause the processor to store the record of the interaction when it is determined that no existing contact information for the other person is stored on the device and that the interaction does not satisfy at least one interaction rule.

22. The non-transitory program storage device of claim 20, wherein the instructions to cause the processor to utilize the obtained contact information for the other person to populate the contacts data store on the device comprise instructions to cause the processor to assign the obtained contact information to a group of automatically created contacts in the contacts data store.

23. The non-transitory program storage device of claim 20, further comprising instructions to cause the processor to obtain, from the user, one or more identifiers of people for whom contact information should not be stored on the device.

24. The non-transitory program storage device of claim 23, wherein the instructions to cause the processor to obtain contact information for the other person based on the identifier comprise instructions to obtain contact information for the other person only if the identifier does not match one of the one or more identifiers of people for whom contact information should not be stored on the device.

25. The non-transitory program storage device of claim 20, further comprising instructions to remove the obtained contact information from the contacts data store if the contact information is not used for a certain time period.
